(19) United States
(12) Patent Application Publication
(10) Pub. No.: US 2014/0080540 A1
(43) Pub. Date: Mar. 20, 2014

(54) PORTABLE MOBILE DEVICE

(71) Applicant: ELITEGROUP COMPUTER SYSTEMS CO.,LTD., Taipei City (TW)

(72) Inventor: Chi-Sheng Hsiao, Taipei City (TW)

(73) Assignee: Elitegroup Computer Systems Co.,Ltd., Taipei City (TW)

(21) Appl. No.: 13/661,005

(22) Filed: Oct. 25, 2012

(30) Foreign Application Priority Data
Sep. 19, 2012 (TW) 101134252

(51) Int. Cl. H04W 88/02

(52) U.S. Cl. 455/556.1

(57) ABSTRACT

A portable mobile device includes a housing, a camera, a processor, and a display. The camera is disposed on the housing for capturing an image of an obstacle. The processor is disposed in the housing for calculating a distance between the obstacle and the housing. The display is disposed on the housing for displaying the image, and for displaying a warning message when the distance is less than a predetermined value.

### BACKGROUND OF THE INVENTION

1. Field of the Invention

The present invention is related to a portable mobile device, and more particularly, to a portable mobile device capable of detecting an obstacle ahead.

2. Description of the Prior Art

With the popularity of portable mobile devices such as smart phones, it has become more often that users are looking down at smart phones while walking and neglecting road conditions ahead. Therefore the users may carelessly fall down, collide with obstacles or other people on the road. Further the users may neglect traffic signals and put themselves in danger.

Therefore developing portable mobile devices that can notify the users of road conditions ahead is a must for smart phone manufactures.

### SUMMARY OF THE INVENTION

An embodiment of the present invention discloses a portable mobile device. The portable mobile device comprises a housing, a camera, a processor, and a display. The camera is disposed on the housing for capturing an image of an obstacle. The processor is disposed in the housing for calculating a distance between the obstacle and the housing. The display is disposed on the housing for displaying the image, and for displaying a warning message when the distance is less than a predetermined value.

Another embodiment of the present invention discloses a portable mobile device. The portable mobile device comprises a housing, a detector, and a display. The detector is disposed on the housing for detecting a distance between an obstacle and the housing. The display is disposed on the housing for displaying a warning message when the distance is less than a predetermined value.

Embodiments of the present invention can notify users of road conditions ahead when the users are looking down at portable mobile devices while walking, thereby preventing the users from falling down or colliding with obstacles.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a portable mobile device according to an embodiment of the present invention.

FIG. 2 is a diagram illustrating a portable mobile device according to another embodiment of the present invention.

FIG. 3 is a diagram illustrating a portable mobile device according to another embodiment of the present invention.

FIG. 4 is a diagram illustrating a portable mobile device according to another embodiment of the present invention.

FIG. 5 is a diagram illustrating a portable mobile device according to another embodiment of the present invention.

### DETAILED DESCRIPTION

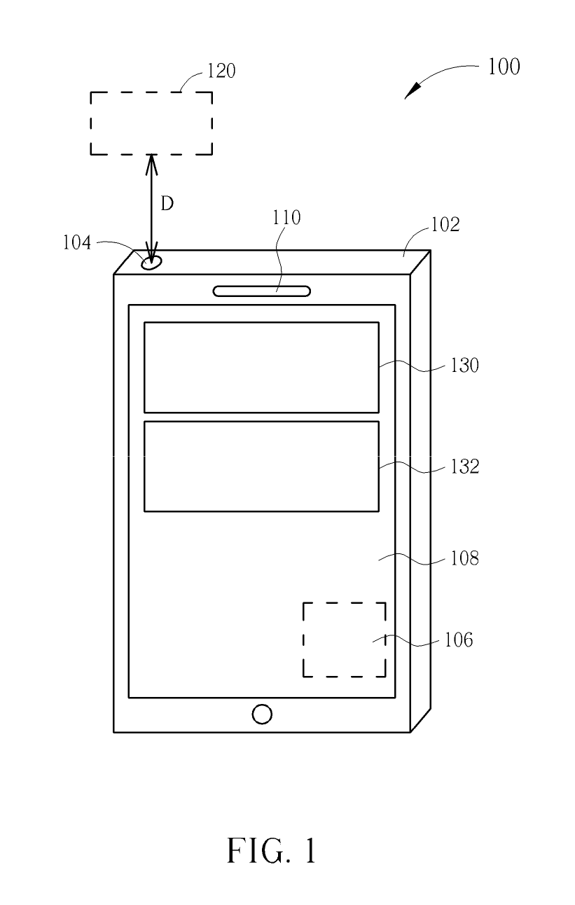

Please refer to FIG. 1 that is a diagram illustrating a portable mobile device 100. The portable mobile device 100 includes a housing 102, a camera 104, a processor 106, a display 108, and a speaker 110. The camera 104, the display 108, and the speaker 110 are disposed on the housing 102, and the processor 106 is disposed in the housing 102. The portable mobile device 100 may be a smart phone, a tablet computer, or other kinds of portable electronic devices.

Operations of the portable mobile device 100 are described as following. A user may in advance adjust the camera 104 to an angle pointing toward a direction where the user is heading to, so that the camera 104 may capture an image 120 of an obstacle ahead of the portable mobile device 100. The image 120 may be displayed in a window 130 on the display 108 by software running on the portable mobile device 100. The user may adjust a size or a position of the window 130, and at least one window 132 showing applications other than the image 120 may be displayed simultaneously on the display 108. In other words, the user may watch the image 120 showing road conditions ahead on the display 108 while using other applications on the portable mobile device 100, that is, the user may watch road conditions ahead on the display 108 while looking down at the portable mobile device 100, thereby preventing the user from falling down or colliding with obstacles.

In another embodiment, the processor 106 may calculate a distance D between the obstacle and the housing 102. When the distance D is smaller than a predetermined value, the display 108 may display a warning message. The warning message may be a warning icon or a change in image color so as to notify the user of road conditions ahead. In still another embodiment, when the distance D is smaller than the predetermined value, the speaker 110 may make a warning sound when the display 108 is displaying the warning message so as to notify the user, thereby preventing the user from falling down or colliding with obstacles.

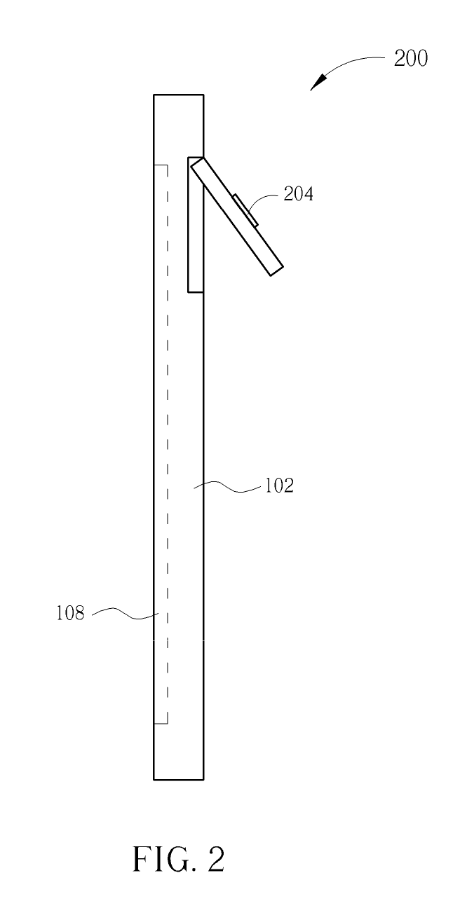

FIG. 2 is a diagram illustrating a portable mobile device 200 according to another embodiment of the present invention. The main difference between the portable mobile device 200 and the portable mobile device 100 is that the camera 204 may be folded in the housing 102 and may pop out automatically or manually whenever it is needed. The camera 204 may change its angle relative to the housing 102 with respect to a position of the obstacle in the image 120 automatically, that is, the camera 204 may adjust its angle to the heading direction of the user. Other components and functions of the portable mobile device 200 are the same as the portable mobile device 100.

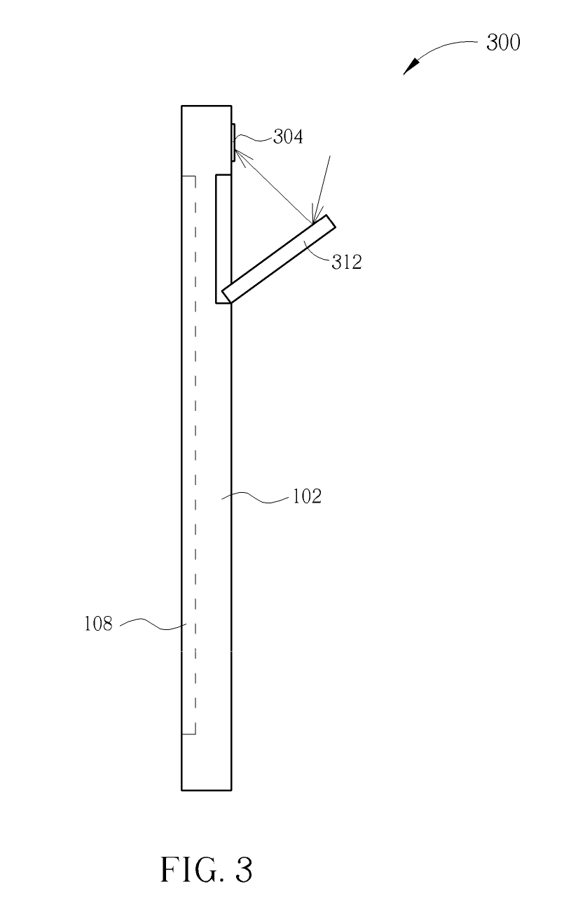

FIG. 3 is a diagram illustrating a portable mobile device 300 according to another embodiment of the present invention. The main difference between the portable mobile device 300 and the portable mobile device 100 is that a mirror 312 is disposed on the housing 102 in the portable mobile device 300. The mirror 312 may reflect light coming from the image 120 to the camera 304. Other components and functions of the portable mobile device 300 are the same as the portable mobile device 100.

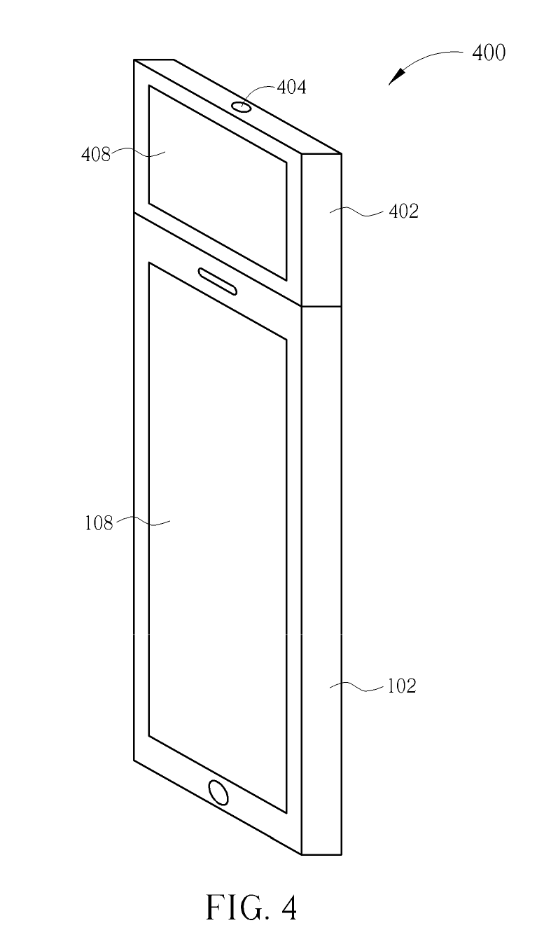

FIG. 4 is a diagram illustrating a portable mobile device 400 according to another embodiment of the present invention. The portable mobile device 400 includes the portable mobile device 100 of FIG. 1 and a case 402 externally connected to the portable mobile device 100. The case 402 includes an external camera 404 and an external display 408. The external camera 404 and the external display 408 are disposed on the case 402. The user may in advance adjust the camera 404 to an angle pointing toward a direction where the user is heading to, so that the camera 404 may capture an image 120 of an obstacle in front of the portable mobile device 400. The image 120 may be displayed in a window on the external display 408 by software running on the portable mobile device 100. At least one window showing applications other than the image 120 may be displayed simultaneously on the display 108. In other words, the user may watch the image 120 showing road conditions ahead on the display 408 while using other applications on the portable mobile device 100, thereby preventing the user from falling down or colliding with obstacles.

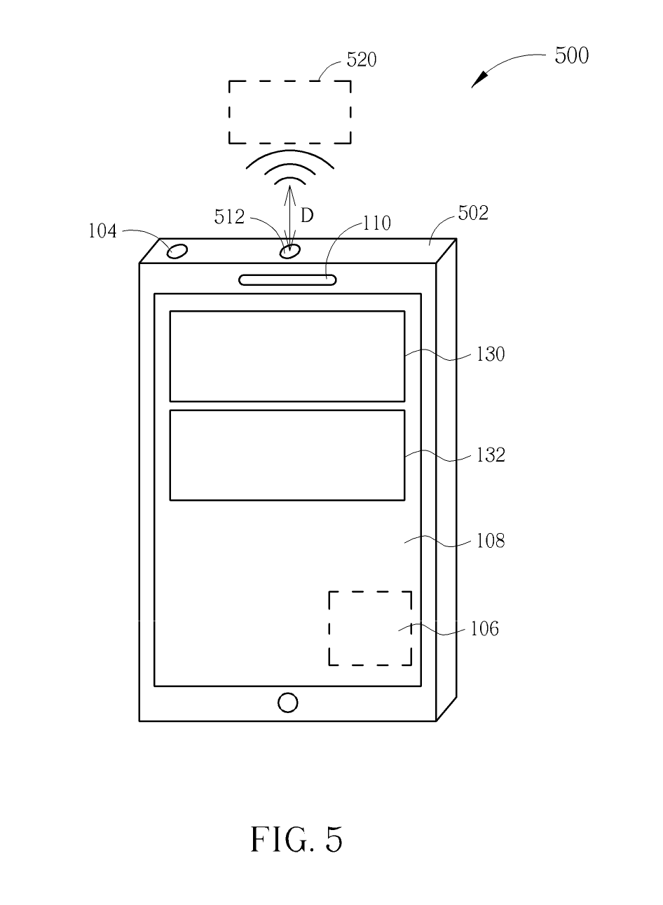

FIG. 5 is a diagram illustrating a portable mobile device 500 according to another embodiment of the present invention. The main difference between the portable mobile device 500 and the portable mobile device 100 is that the portable mobile device 500 includes a detector 512, which is disposed on the housing 102. The detector 512 may be a device similar to a parking sensor of a car or other distance detecting devices. The detector 512 may detect a distance D between an obstacle 520 and the housing 102. When the distance D is smaller than a predetermined value, the display 108 may display a warning message. The warning message may be a warning icon or a change in color on the display 108 so as to notify the user of road conditions ahead. In another embodiment, when the distance D is smaller than the predetermined value, the speaker 110 may make a warning sound when the display 108 is displaying the warning message so as to notify the user, thereby preventing the user from falling down or colliding with obstacles.

In summary, the present invention can notify the user of road conditions and obstacles ahead when the user is looking down at and using the portable mobile device while walking, thereby preventing the user from falling down or colliding with obstacles or other people.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable mobile device comprising:
a housing;
a camera disposed on the housing for capturing an image of an obstacle;
a processor disposed in the housing for calculating a distance between the obstacle and the housing; and
a display disposed on the housing for displaying the image, and for displaying a warning message when the distance is less than a predetermined value.

2. The portable mobile device of claim 1 wherein an angle between the camera and the housing changes with a position of the obstacle.

3. The portable mobile device of claim 1 further comprising:
a mirror disposed on the housing for reflecting light from the image to the camera.

4. The portable mobile device of claim 1 further comprising:
a speaker disposed on the housing for making a warning sound when the distance is less than the predetermined value.

5. The portable mobile device of claim 1 wherein a size of the image displayed on the display is adjustable.

6. The portable mobile device of claim 1 wherein a position of the image displayed on the display is adjustable.

7. The portable mobile device of claim 1 wherein the display simultaneously displays the image and at least one window other than the image.

8. A portable mobile device comprising:
a housing;
a camera disposed on the housing;
a processor disposed in the housing;
a display disposed on the housing; and
a case coupled to the housing, comprising:
an external camera disposed on the case for capturing an image of an obstacle; and
an external display disposed on the case for displaying the image;
wherein the processor is for calculating a distance between the obstacle and the housing, and controlling the external display for displaying a warning message when the distance is less than a predetermined value.

9. The portable mobile device of claim 8 further comprising:
a speaker disposed on the housing for making a warning sound when the distance is less than the predetermined value.

10. A portable mobile device comprising:
a housing;
a detector disposed on the housing for detecting a distance between an obstacle and the housing; and
a display disposed on the housing for displaying a warning message when the distance is less than a predetermined value.

11. The portable mobile device of claim 10 wherein the detector is a radar.

12. The portable mobile device of claim 10 further comprising:
a speaker disposed on the housing for making a warning sound when the distance is less than the predetermined value.

13. The portable mobile device of claim 10 wherein a size of the image displayed on the display is adjustable.

14. The portable mobile device of claim 10 wherein a position of the image displayed on the display is adjustable.

15. The portable mobile device of claim 10 wherein the display simultaneously displays the image and at least one window other than the image.
